(19) United States
(12) Patent Application Publication
(10) Pub. No.: US 2020/0060463 A1
(43) Pub. Date: Feb. 27, 2020

(54) Hand Operated Coffee Brewer

(71) Applicant: TJ Designs, Inc., Calgary (CA)

(72) Inventors: John Gardiner, Calgary (CA); Taylor Carcasole, Calgary (CA); Grant Unsworth, Calgary (CA)

(21) Appl. No.: 16/111,140

(22) Filed: Aug. 23, 2018

(51) Int. Cl. A47J 31/32; A47J 31/20; A47J 31/44

(52) U.S. Cl. CPC A47J 31/32; A47J 31/4407; A47J 31/20

(57) ABSTRACT

A coffee brewing apparatus comprising a canister for holding coffee grounds and hot water in which the coffee brews. The canister has a closable opening through which the coffee grounds and hot water are poured. A filter covers an opening at the bottom of the canister through which brewed coffee flows out of the canister. A hand pump is coupled to an opening in the canister, operable to increase air pressure inside the canister. The canister inhibits the leakage of air or liquid while the coffee is brewing. The hand pump is used to increase air pressure inside the canister to a high pressure sufficient to push the brewed coffee through the filter and out of the canister.

### TECHNICAL FIELD

Embodiments generally relate to coffee brewing apparatus, and in particular to a hand operated, pressurized coffee brewing apparatus.

### BACKGROUND

There are many types of coffee brewing apparatus. In some environments, a single cup, personal use apparatus is preferred to brewing a whole pot. Existing solutions include an inverted truncated cone-shaped device into which a small conical filter is placed. The device is set on top of a coffee cup with conical filter pointing down, coffee grounds are spooned into the filter, hot water is poured into the filter covering the grounds, and the water drips through the grounds and filter and into coffee cup beneath them. The same type of apparatus is available in a variety of shapes and sizes, but all work in essentially the same way. However, there is no way to control any aspect of this device's operation. The water drips through the grounds at a speed that can't be varied, and it produces a cup of coffee there's no way to improve upon.

A so-called French press consists of a narrow cylindrical beaker, usually made of glass or clear plastic, equipped with a metal or plastic lid and plunger that fits tightly in the cylinder and has a fine stainless steel wire or nylon mesh filter. Coffee is spooned into the canister with the plunger removed, hot water is poured into the canister, and the coffee is brewed for a few minutes. The coffee is served by pressing the plunger from the top to near the bottom of the beaker, collecting the coffee grounds as it drops. At its bottom position, the grounds are collected in the bottom of the beaker, and the brewed coffee can be poured into a cup. This is an improvement over drip coffee, at least in that the brewing time can be adjusted to vary the strength of the coffee.

A device called an AeroPress® works similarly to a French press, with the exception that the French press' working principle is the coffee is immersed in water, and the plunger is used simply to separate the coffee grounds from the brewed coffee. Although it is probably true that pushing on the plunger produces some amount of hydraulic pressure, it is of little note. In contrast, the AeroPress® traps air between the plunger and the surface of the brewed coffee. The air is visibly compressed when pushing on the plunger, which offers at least some measure of control over the pressure applied, which can controllably affect the taste of the coffee being prepared. However, the pressure is limited by the strength of the AeroPress® operator, and the pressure may only be applied for a few seconds at the end of the brew cycle.

A manually operated apparatus that offers greater control of more variables would be of use to coffee drinkers is pursuit of the best possible cup of coffee.

### SUMMARY

A coffee brewing apparatus comprising a canister for holding coffee grounds and hot water in which the coffee brews. The canister has an opening through which the coffee grounds and hot water are poured, after which the opening is closed. A filter covers an opening at the bottom of the canister through which brewed coffee flows out of the canister. A hand pump is coupled to an opening in the canister, operable to increase air pressure inside the canister. The hand pump is used to increase air pressure inside the canister to a high pressure sufficient to push the brewed coffee through the filter and out of the canister.

It is to be understood that both the foregoing general description and the following detailed description are exemplary and explanatory, and are not intended to be limiting unless otherwise specified. In particular, they are intended to provide further explanation of the invention as claimed.

### BRIEF DESCRIPTION OF THE FIGURES

The figures illustrate a disclosed embodiment and aspects of the invention and, together with the description, serve to explain the principles of the invention, the scope of which is determined by the claims. In the figures, like reference numerals indicate like parts.

FIG. 1 shows a grayscale perspective view illustration of a fully assembled exemplary embodiment in accordance with the disclosure. FIG. 2 shows a view of the same apparatus disassembled.

### DETAILED DESCRIPTION

It is to be understood that the illustrations and descriptions provided herein may have been simplified to illustrate aspects that are relevant for a clear understanding of the invention, while eliminating for the purpose of clarity other aspects that may be found in typical coffee brewing devices. Those of ordinary skill in the pertinent art may recognize that other elements and/or steps may be desirable or necessary to implement the apparatus described herein. Because such elements and steps are well known in the art, and because they do not facilitate a better understanding of the present disclosure, a discussion of such elements and steps may not be provided herein. However, this disclosure is deemed to inherently include all such elements, variations, and modifications to the described aspects that would be known to those of ordinary skill in the pertinent art.

It will be readily understood that aspects of the present invention may be formed and arranged in a variety of different configurations. Thus, the following detailed description and the attached figure are not intended to limit the scope of the invention as claimed, but are merely representative of selected embodiments of the invention. The aspects and characteristics described and illustrated may be combined in any suitable manner in one or more embodiments. For example, the phrase “exemplary embodiment”, “embodiments”, and other similar language should be understood to mean the described aspects and characteristics may pertain to at least one embodiment of the invention, and do not necessarily refer to the same embodiment(s).

In the embodiments and aspects disclosed and illustrated herein, a manually operated immersion coffee brewer utilizes a hand pump to increase air pressure in a sealed container to force brewed coffee through a filter into a cup below. The combination of the hand pump and pressure gauge allow for precision brewing at a pressure of the users choice.

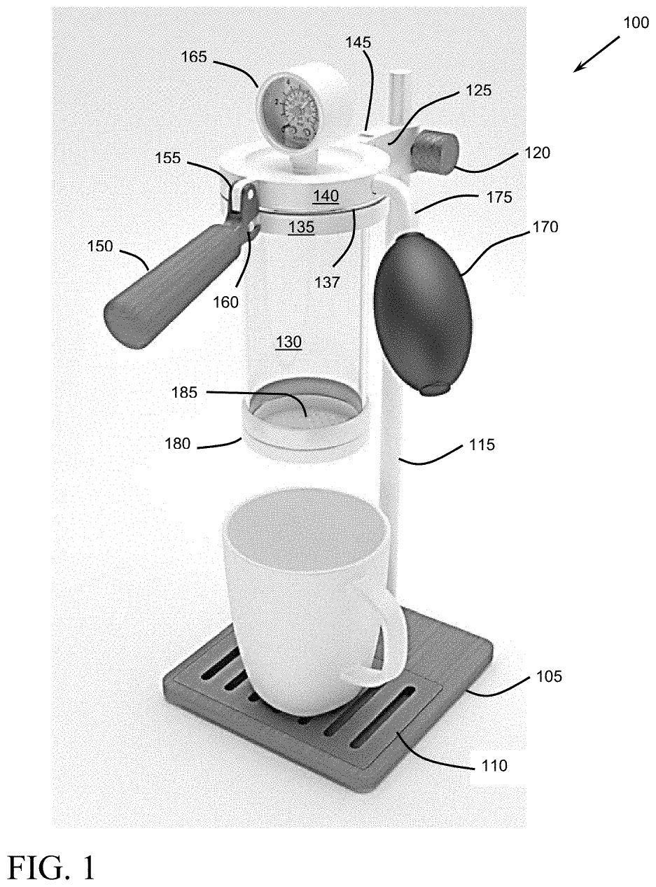

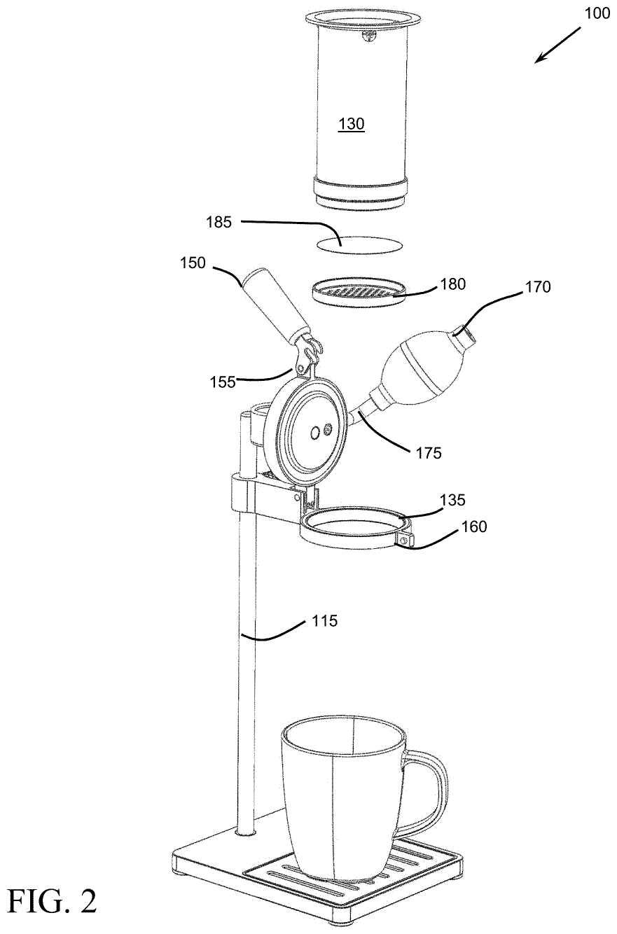

Referring now to the figures, FIGS. 1A and 1B illustrate an exemplary embodiment in the form of a free standing coffee brewing apparatus 100. In FIG. 1, the apparatus is assembled and closed, in the position it would be while brewing coffee (coffee and hot water are not shown in the figure for clarity). In FIG. 2, the apparatus is disassembled and open, as it would be for cleaning. In the embodiment shown, the apparatus is equipped with a large, heavy base 105, for example made of metal, stone, or other dense material, to ensure stability of the free standing apparatus. Within the base is a grating 110 to collect possible spillover. Attached to the base is a metal rod 115, that is used to secure other elements in place, and to adjust the height of the brewing mechanism attached to it. Height adjustment is effected using a hand screw 120 or the like that can be hand tightened to secure a frame 125 at a select height to the rod 115.

The brewing components comprise a tube 130, preferably made of thick or tempered glass or other strong, transparent material. A bottom piece 180 is removably coupled to the tube as will be described, to form a canister in which the brewing of coffee takes place. The brewing canister is placed into a ring 135 that is part of the frame 125. In an embodiment, the tube 130 is wider at the top than the bottom, to keep it from falling through the ring 135 when placed therein. For example, the tube may be flared at the top, or may be formed as a slightly frustoconical shape. Alternatively, as shown, a cylindrical tube 130 may be used, at or near its top edge provided with a lip 137 extending outward to rest flush on the top of the ring 135 when the canister is placed in the ring.

A lid 140 is pivotally coupled to the frame 125 via a hinge 145, which may be spring- or resistance-limited, to open and close the lid 140. A lever or handle 150 is pivotally coupled to the lid 140 at hinge 155, operable to clamp the lid 140 onto the ring 135 by engaging a pin 160 that extends from and is part of the ring 135, although other clamping mechanisms and arrangements may be used. In embodiments, a compressible material, for example rubber or a similarly durable, flexible material 143, may be incorporated into a matching surface of at least one of the ring 135 and the lid 140, to create an air- and liquid-tight seal when they are clamped together. Alternatively, in the case of a cylindrical tube having a lip 137 that rests on the ring 135 as shown, the matching surfaces of both the top of the ring and the bottom of the lid may be provided with a compressible material. In alternative embodiments, an o-ring, gasket, or the like, can be placed between matching surfaces to ensure a tight seal between them when clamped together.

A gauge 165 is coupled to the top of the lid 140 at the location of a passage or hole 167 through the lid. The gauge 165 may be permanently coupled to the lid 140, such as with a permanent adhesive, weld, or other permanent coupling mechanism. Or, the gauge 165 may be removeably coupled to the lid, for example via a threaded coupling or the like. In any case, when the lid 140 is clamped onto the ring 135 with the canister 130 set in place through the ring, the gauge is coupled to the lid 140 to form an air passage to the interior of the canister through the opening 167 in the lid, for measuring air pressure within the canister 130. A hand pump 170 or other pumping element is also coupled to the lid (or the canister) to form an air passage to the interior of the canister to increase the air pressure in the canister 130. The hand pump 170 comprises a flexible chamber or bulb made of rubber or similarly flexible and resilient material, that can be squeezed to increase air pressure in the canister to a higher than ambient pressure. When the bulb is squeezed, a first check valve coupled between the bulb and the canister opens to let pressurized air flow from the bulb into the brewing chamber, and a second check valve coupled between the bulb and the ambient air closes. Afterward, when the bulb is released it rebounds to its uncompressed shape, closing the first check valve to prevent the compressed air in the brewing chamber from escaping, and opening the second check valve to let ambient air flow into the flexible rubber pump.

In embodiments, the hand pump 170 may be coupled via a rigid hollow tube 175 through an opening into the canister, such as a second opening in the lid 140. In embodiments, the tube 175 may be permanently coupled to the lid 140 around the opening, such as with a permanent adhesive, weld, or other permanent coupling mechanism. Or, the tube 175 may be removeably coupled to the lid 140 around the opening, for example via a threaded coupling or the like. In embodiments, the tube 175 may be flexible or include a flexible portion equipped with a valve open to ambient air (not shown) that can be closed when using the hand pump to increase pressure in the canister 130, and opened to decrease pressure in the canister, for example using a thumb screw or the like. In embodiments, other air pressure controlling pump arrangements, including a powered pump (not shown), may alternatively be used.

A bottom piece 180 is removably coupled to the bottom edge of canister tube 130 to form the bottom of the brewing canister. For example, the bottom of tube 130 and the bottom piece 180 may be equipped with matching threads so the bottom piece can be screwed onto the tube. In embodiments, the bottom piece 180 and the tube 130 may be formed to comprise flat matching surfaces when coupled together. If so, a matching surface of the tube 130 or the bottom piece 180 can be provided with a compressible material to provide an air- and liquid-tight seal when they are coupled together. Alternatively, a compressible o-ring or gasket can be inserted between the surfaces when they are coupled together. In embodiments, the bottom piece is formed to have a short wall around its circumference to hold coffee grounds. In an embodiment, the wall may be between ¼ inch and 1 inch high, such as ⅔ inch high, although other wall heights and ranges may also be used without departing from scope of the invention. The wall may be disposed inside or outside of the tube 130 when joined with the bottom piece 180. In embodiments, at least a portion of the bottom piece comprises a metal filter 183 through which brewed coffee passes, to be captured in a cup sitting underneath. In embodiments, a paper filter 185 sized to fit the bottom of the canister may optionally be placed on top of the metal filter before coupling the bottom piece 180 to the canister tube 130. In embodiments, the bottom piece 180 does not comprise a metal filter, but is provided with holes. In such embodiments, use of the paper filter 185 is not optional, and the filtering is accomplished by the paper filter 185 alone. The paper filter 185 may be flat, or alternatively may be formed with a fluted or folded circumferential portion that is held in place by any mechanism known in the art, to prevent coffee grounds from passing around an edge of the filter into the cup below.

Using the described apparatus to brew coffee is straightforward. The following assumes the apparatus is initially clean and fully assembled. To brew coffee, a user must have pre-ground coffee beans and hot water. If a paper filter is used, the user unscrews the bottom piece 180 from canister tube 130, places the paper filter in the bottom piece 180, and screws the bottom piece 180 back onto the bottom of the tube 130 to form the canister. If the bottom piece comprises a suitable metal filter, then a paper filter need not be used, and this step is optional.

With the lid 140 in the open position, the user puts ground coffee into the canister through the open top of the canister. The user also adds hot water through the same opening. The user closes and fastens top lid by lowering the lid 140 onto the canister, and clamps it shut by lowering the lever 150. The user places a cup on the base plate 105 under the canister, and waits a desired amount of time as the coffee brews in the canister. While brewing, the ambient air pressure outside the canister is sufficient to prevent the coffee from dripping out, in part because coffee dripping out of the canister would leave unfilled the space in the canister the coffee had occupied. This would tend to reduce the air pressure in the canister and, because there is no clear pathway for air to enter the canister to equalize the pressure, the slightly greater ambient air pressure outside the canister pushes on the bottom of the canister to keep the coffee from dripping out through the filter. In addition, as the coffee and the air in the canister cool, the air pressure inside the canister drops, thereby increasing the pressure differential and causing the pressure of the ambient air to push on the bottom of the canister with gradually increasing force.

When desired, typically after just a few minutes, the user squeezes the hand pump 170 to increase the air pressure inside the canister. As the air pressure inside the canister increases, the brewed coffee begins to pass through the filter into the cup. The user pumps until a desired air pressure is reached, as indicated on the gauge 165. The increased pressure of the air inside the canister pushes the coffee through the filter and into the cup. In addition, the added pressure expresses some of the natural oils and phytonutrients from the ground coffee into the brewed coffee. As the brewed coffee exits the canister, if the decreasing volume of coffee remaining in the canister causes the air pressure therein to drop below a desired threshold, the user can use hand pump 170 to pump more air into the canister, increasing the pressure.

When the desired amount of coffee has drained out of the canister, the user releases the excess air pressure from the canister, for example by opening a valve (not shown) in the pump tube 175, and the apparatus is ready for cleaning. To clean the apparatus, the user lifts up on the lever 150 to unclamp the lid 140, and opens the lid. The user lifts the canister out of the support ring 135, pours any remaining coffee from the canister, removes the bottom piece 180 from the tube 130, discards the used coffee grounds (and the paper filter 185 if one is used), and rinses the tube 130 and the bottom piece 180. The user can then reassemble the apparatus by placing a fresh paper filter 185 (if one is used) in the bottom piece 180, and coupling the bottom piece 180 back onto bottom of the tube 130 to form the brewing canister. The user then inserts the canister back into the support ring 135 attached to the support structure 125.

References herein to “embodiments,” “an embodiment,” or similar phrases, indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

Although only a single exemplary embodiment of the invention has been described and illustrated with particularity, it is noted that the description and illustrations have been made by way of example only. Numerous changes in the details of construction, combination, shape, and arrangement of parts and steps may be made without deviating from the scope of the invention. For example, coffee may be directed through one or more tubes and channels into a coffee cup that is not disposed underneath the filter element; the canister may have shapes other than those described, the pump and gauge may operate on different principles than described, the support structure and frame may be differently shaped and arranged, and the like, without changing the scope of the invention as defined by the claims. Accordingly, such changes are understood to be inherent in the invention. It is noted the invention is not limited except by the appended claims and the elements explicitly recited therein, and the scope of the claims should be construed as broadly as the prior art will permit. It should also be noted that elements of all of the claims may be combined with each other in various combinations. These combinations are understood to be included within the scope of the claims even if they have not been expressly recited, unless the claims as recited cannot be construed to include such combinations.

What is claimed is:

1. A coffee brewing apparatus comprising:
a canister defining an interior space for holding coffee grounds and hot water in which the coffee brews, the canister having a closable opening through which the coffee grounds and hot water are introduced into the interior space;
a filter covering an opening at the bottom of the canister through which brewed coffee flows out of the canister; and
a hand pump arranged to form a passage to the interior space of the canister, operable to increase the pressure of air in the interior space when the hand pump is squeezed;
wherein the canister inhibits leakage of air or liquid while the coffee is brewing, and the hand pump is operable to increase the air pressure inside the canister to a higher than ambient pressure sufficient to push the brewed coffee through the filter out of the canister.

2. The apparatus of claim 1, further comprising:
a bottom piece configured to cover the opening at the bottom of the container, and removably couplable to the bottom of the container around the opening to form a liquid-tight seal around the opening at the higher pressure.

3. The apparatus of claim 1, further comprising:
a lid configured to cover and close the opening through which the coffee grounds and hot water are introduced into the container, and removably couplable to the canister to cover the opening.

4. The apparatus of claim 3, further comprising:
a clamp movably coupled to the lid and operable to clamp the lid onto the canister to cover the opening.

5. The apparatus of claim 4, further comprising:
an air pressure gauge coupled to the lid or to the canister near its top, operable to indicate the pressure of air inside the canister when the lid is clamped to the canister.

6. The apparatus of claim 1, further comprising:
a stand;
a rigid support immovably coupled to the stand;
a frame; and
a tightener configured to immovably couple the frame to the rigid support at a select position.

7. The apparatus of claim 6, wherein the tightener comprises a thumb screw.

8. The apparatus of claim 6, wherein:
the lid is pivotally coupled to the frame via a hinge; and
the clamp has a handle pivotally coupled to one of the lid and the frame operative to clamp the lid to the canister in a first position to form a seal, and to unclamp the lid from the canister in a second position.

9. The apparatus of claim 1, wherein:
the canister has a transparent side portion through which the canister's contents can be viewed; and
the bottom piece and filter form a bottom of the canister.

10. The apparatus of claim 9, wherein the bottom piece and the bottom of the canister body have matching threads, whereby the bottom piece can be screwed onto and off of the canister body.

11. The apparatus of claim 1, further comprising a hollow tube coupled at a first end to the hand pump, and forming an air tight airway from the pump through an opening into the canister at the high pressure.

12. The apparatus of claim 6, wherein the rigid support is in the shape of a straight bar, and the frame comprises a portion in the shape of a ring through which the canister can be inserted.

13. The apparatus of claim 12, wherein:
the base comprises a grating on which a cup may be placed configured to capture spillage, and
the top of the canister is configured to hang from a top rim of the ring, and the ring and the canister placed therein are positioned so that coffee passing out of the canister through the filter falls into the cup.
